(19) United States
(12) Patent Application Publication
(10) Pub. No.: US 2015/0381480 A1
(43) Pub. Date: Dec. 31, 2015

(54) NETWORK SYSTEM, RESOURCE CONTROL DEVICE, AND VIRTUAL MACHINE GENERATION DEVICE

(71) Applicant: NEC Corporation, Tokyo (JP)

(72) Inventor: Ryosuke OHARA, Tokyo (JP)

(21) Appl. No.: 14/768,296

(22) PCT Filed: Sep. 10, 2013
(86) PCT No.: PCT/JP2013/005343

§ 371 Date: Aug. 17, 2015

(30) Foreign Application Priority Data
Mar. 1, 2013 (JP) 2013-040956

(51) Int. Cl. H04L 12/721; H04L 12/947; H04L 12/46; H04L 12/741

(52) U.S. Cl. CPC H04L 45/38; H04L 45/745; H04L 49/25; H04L 12/4641

(57) ABSTRACT

In a resource control device (150), a play setting control unit (154) transmits, to an OFC (170), flow information necessary for generating a flow entry corresponding to communication by a virtual machine (130), in parallel with issuance of an instruction to generate the virtual machine (130) by a generation instruction issuing unit (152). Upon receiving the flow information from the play setting control unit (154), the OFC (170) generates a flow entry based on the flow information and sets the flow entry to the OFS (160) that relays the communication by the virtual machine (130). Thus, in a network system in which OpenFlow control is performed, the time required to start provision of services by the virtual machine is shortened.

### TECHNICAL FIELD

The present invention relates to a network system, and more particularly, to a network system that uses an OpenFlow technique.

### BACKGROUND ART

With the explosive increase in traffic due to the widespread use of mobile terminals, there is a demand for techniques that visualize traffic and optimize a network bandwidth. SDN (Software Defined Networking) has received attention as a method to achieve such techniques.

SDN is generally composed of a technique to virtualize a network and a technique to control a network.

According to the technique to virtualize a network, the network from the perspective of a virtual machine (VM) can be regarded as a flat network that is independent of the physical network configuration. Accordingly, the network can be divided into segments, for example, for the convenience of a server administrator. On the contrary, there is no need for the physical network to consider how the network of the virtual machine is divided into segments, which enables the physical network to focus on transfer of packets flowing between physical servers.

OpenFlow is known as a standard for the technique to control a network. OpenFlow is a technique in which a transfer operation and the like of each network switch in a network system are controlled by an external controller in a centralized manner.

A network switch compatible with OpenFlow is called an OpenFlow switch (hereinafter referred to as “OFS”). The OFS holds information, such as a protocol type and a port number, in a flow table, performs a flow control, and obtains statistical information.

The flow table held by the OFS is set by a control device called an OpenFlow controller (hereinafter referred to as “OFC”). The OFC is disposed so as to be separated from the OFS. The OFC sets a communication path between nodes, and also sets flow entries in which rules for specifying a flow (packet data) are respectively associated with actions for specifying processing for the flow in a flow table held by the OFS on the path. The OFS on the communication path processes received packet data according to the flow entries set by the OFC.

In response to a request from the OFS, the OFC performs, for example, calculation of the communication path and updating of the flow table held by the OFS on the communication path. For example, when the OFS has received packet data which is not defined in the flow table held by the OFS, the OFS notifies the OFC of information about the packet data. When the packet data received by the OFS is not defined in the flow table of the OFS, the packet data is referred to as a first packet for the OFS. In association with this, a notification sent to the OFC by the OFS which has received the first packet is referred to as a query about the first packet.

Upon receiving the query about the first packet from the OFS, the OFC determines a communication path by specifying a transfer source and a transfer destination based on header information of the packet data, and updates the flow table of each OFS by generating flow entries (rule+action) to be set to each OFS.

Techniques for improving various aspects of network systems using OpenFlow have been proposed.

For example, Patent Literature 1 discloses a technique that achieves load distribution using OpenFlow. In a system to which the technique is applied, service servers that provide services to their clients via the OFS monitor their own load status and issue a load distribution request to the OFS when their own load is equal to or more than a threshold. Upon receiving the load distribution request from any one of the service servers, the OFS changes the flow table, which is set to the OFS, according to the load distribution request.

Patent Literature 2 discloses a technique for improving the fault tolerance of a network system by using OpenFlow. In the system to which the technique is applied, a plurality of OFCs are provided. In the case of instructing the OFSs to set a flow entry, the plurality of

OFCs add a priority to the flow entry setting instruction. When the priority of the flow entry setting instruction received from the OFCs is higher than the priority of the flow entry set in the OFS, the OFS overwrites the flow entry set in the OFS with the received flow entry. On the other hand, when the priority of the flow entry setting instruction received from the OFCs is lower than the priority of the flow entry set in the OFS, the OFS refuses to set the received flow entry.

### CITATION LIST

### Patent Literature

Patent Literature 1: Japanese Unexamined Patent Application Publication No. 2011-170718

Patent Literature 2: Japanese Unexamined Patent Application Publication No. 2011-166384

### SUMMARY OF INVENTION

### Technical Problem

Referring now to FIG. 8, a flow from the generation of a virtual machine to the start of provision of services by the virtual machine will be considered. As shown in FIG. 8, this flow generally includes the following steps.

### <Step A1>

An instruction to generate a virtual machine is issued to a control program called a hypervisor (HV) which is implemented on a host machine.

### <Step A2>

Upon receiving the generation instruction issued in step A1, the hypervisor generates the virtual machine according to the received instruction.

### <Step A3>

The virtual machine generated by the hypervisor in step A2 activates an OS (Operating System) and an AP (Application) corresponding to a service to be provided.

### <Step A4>

Upon starting the service, the virtual machine executes a first flow communication to the OFS and transmits packet data.

### <Step A5>

Since the virtual machine is obtained immediately after the generation of the source of the packet data transmitted in Step A4, the packet data is a first packet for the OFS which has received the packet data. Accordingly, the OFS sends a query about the first packet to the OFC and requests a flow entry corresponding to the OpenFlow.

### <Step A6>

According to the query about the first packet sent from the OFS in Step A5, the OFC sets a flow entry to each OFS and updates the flow table.

### <Step A7>

After that, the virtual machine can perform communication via the OFS and starts to provide services.

As is obvious from the above flow, even though the virtual machine is ready to provide services when Step A3 is completed, a waiting time for Steps A4 to A6 is required until the communication via the OFS is enabled, that is, until the provision of services is actually started.

The present invention has been made in view of the above-mentioned circumstances, and provides a technique for shortening the time required to start the provision of services by a virtual machine in a network system in which OpenFlow control is performed.

### SOLUTION TO PROBLEM

An exemplary aspect of the present invention is a network system. The network system includes a flow controller, a virtual machine generation unit, and a play setting control unit.

The flow controller sets a flow entry to a switch on a communication path. The switch relays a received packet according to the flow entry included in a flow table held by the switch.

The virtual machine generation unit generates a virtual machine according to an instruction to generate the virtual machine that performs communication through the switch.

The play setting control unit transmits, to the flow controller, information necessary for generating a flow entry corresponding to the communication by the virtual machine generated by the virtual machine generation unit, in parallel with issuance of the instruction to generate the virtual machine.

The flow controller generates the flow entry according to the necessary information received from the play setting control unit, and sets the flow entry to the switch.

Note that implementations of the network system according to the above-mentioned aspect in the form of a device and a method, the play setting control unit included in the network system, a method corresponding to the play setting control unit, programs for causing a computer to execute these methods, and a recording medium storing the programs are effective as aspects of the present invention.

### ADVANTAGEOUS EFFECTS OF INVENTION

According to the present invention, it is possible to shorten the time required to start the provision of services by a virtual machine to, for example, a network system in which OpenFlow control is performed.

### BRIEF DESCRIPTION OF DRAWINGS

FIG. 1 is a diagram showing a network system according to a first exemplary embodiment;

FIG. 2 is a table showing a configuration of a flow table held by an OFS in the network system shown in FIG. 1;

FIG. 3 is a table showing rules in each flow entry included in the flow table;

FIG. 4 is a table showing types of action in each flow entry included in the flow table;

FIG. 5 is a flowchart showing processing in the network system shown in FIG. 1 from the issuance of an instruction to generate a virtual machine to the start of provision of services by the virtual machine;

FIG. 6 is a diagram showing a network system according to a second exemplary embodiment;

FIG. 7 is a flowchart showing processing in the network system shown in FIG. 6 from the issuance of an instruction to generate a virtual machine to the start of provision of services by the virtual machine; and

FIG. 8 is a table showing a flow of an OpenFlow network system of related art from the issuance of an instruction to generate a virtual machine to the start of provision of services by the virtual machine.

### DESCRIPTION OF EMBODIMENTS

Exemplary embodiments of the present invention will be described below with reference to the drawings. To clarify the explanation, the following description and the drawings are abbreviated and simplified as appropriate. It can be understood by those skilled in the art that elements illustrated in the drawings as functional blocks for performing various processes can be implemented in various forms by a combination of hardware and software (program). Accordingly, the functional blocks are not limited to one of hardware and software. Note that the same elements are denoted by the same reference numerals throughout the drawings, and thus a repeated description thereof is omitted as needed.

The above-mentioned program can be stored and provided to a computer using any type of non-transitory computer readable media. Non-transitory computer readable media include any type of tangible storage media. Examples of non-transitory computer readable media include magnetic storage media (such as floppy disks, magnetic tapes, and hard disk drives), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

### First Exemplary Embodiment

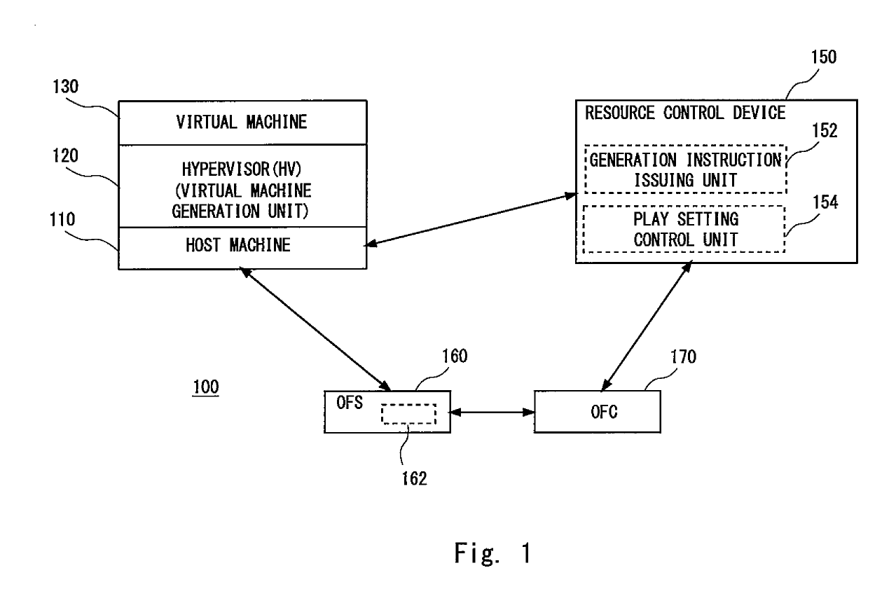

FIG. 1 shows a network system 100 according to a first exemplary embodiment. The network system 100 is a system to which an OpenFlow technique is applied. The network system 100 includes a host machine 110, a resource control device 150, an OFS (OpenFlow switch) 160, and an OFC (OpenFlow controller) 170. The host machine 110, the resource control device 150, the OFS 160, and the OFC 170 are connected to each other via a network (not shown) such as a LAN (Local Area Network) or a WAN (Wide Area Network).

A hypervisor 120 is implemented on the host machine 110. The hypervisor 120 can operate as a virtual machine generation unit that generates a virtual machine on the host machine 110.

The resource control device 150 includes a generation instruction issuing unit 152 that issues a virtual machine generation instruction to the host machine 110, more specifically, the hypervisor 120 in the host machine 110. The generation instruction issuing unit 152 has the same function as that of a device which issues a virtual machine generation instruction in a network system of this type, and thus a detailed description thereof is herein omitted.

In this exemplary embodiment, the resource control device 150 also includes a play setting control unit 154 as well as the generation instruction issuing unit 152. The play setting control unit 154 will be described in detail later.

The OFS 160 is a switch that relays communication between nodes on the network system 100. The OFS 160 is a physical switch or a virtual switch. The OFS 160 holds a flow table 162 and processes a received flow according to each flow entry included in the flow table 162.

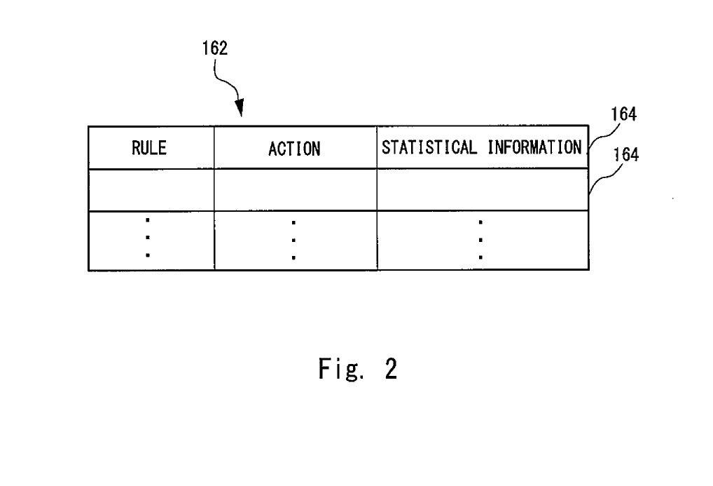

FIG. 2 shows the flow table 162 held by the OFS 160. The flow table 162 includes one or more flow entries 164. Each of the flow entries 164 is composed of “rule”, “action”, and “statistical information”.

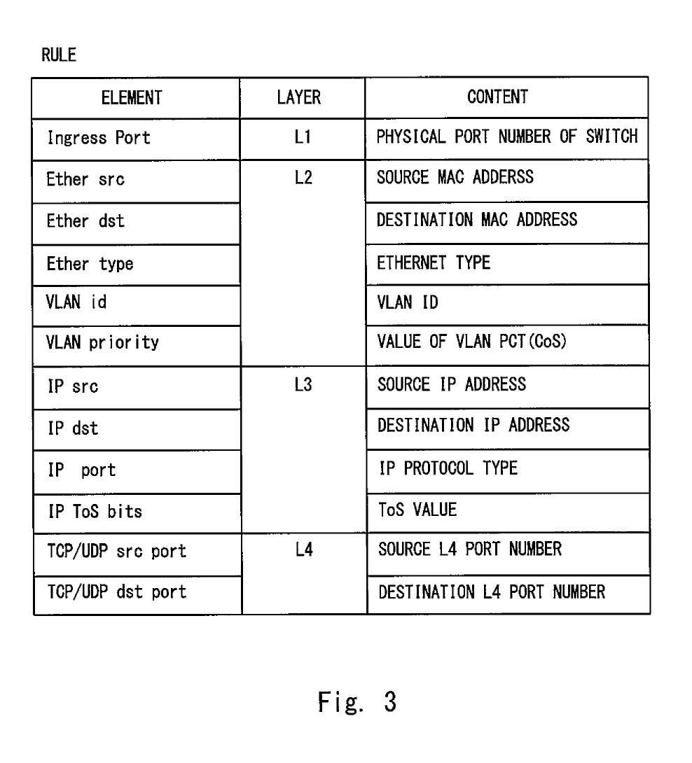

FIG. 3 shows the configuration of “rule” in each flow entry 164 that is defined in OpenFlow Ver. 1.0. As shown in FIG. 3, the rule includes 12 elements in total which are defined for each of four layers, i.e., a physical layer (L1), a data link layer (L2), a network layer (L3 layer), and a transport layer (L4).

Header information of a packet includes the elements shown in FIG. 3. The OFS 160 determines whether or not the packet is a first packet by comparing received packet header information with the rule in each flow entry 164 of the flow table 162 held by the OFS 160. Specifically, when the flow entries 164 of the flow table 162 include a flow entry including the rule, all the elements of which match the received packet header information, the OFS 160 determines that the packet is not the first packet, and performs, on the packet, the processing indicated by the action in the flow entry. On the other hand, when the flow entries 164 do not include such a flow entry, the OFS 160 determines that the packet is the first packet, and transmits a notification including the header information to the OFC 170.

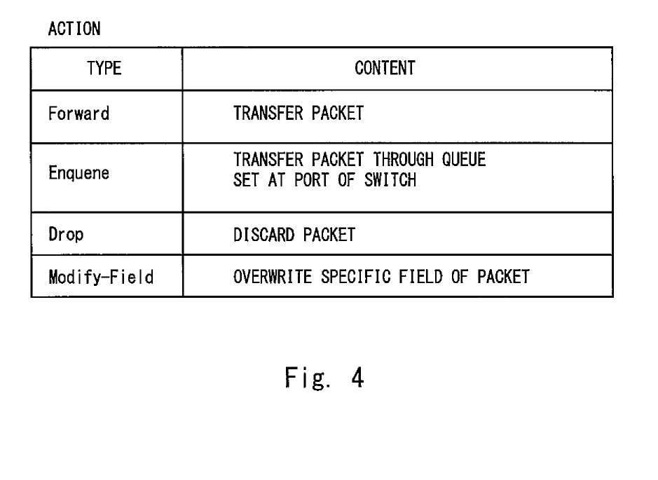

FIG. 4 shows types of “action” in each flow entry 164. The “action” indicates processing to be performed on the packet that is determined to comply with the rule. As shown in the figure, there are four types of action. The detailed description of each type of action will be omitted.

The statistical information in each flow entry 164 is a field for managing the throughput and the frequency of occurrence of the flow communication that complies with the rule. For example, the number of packets, the number of bytes, and an elapsed time from the generation of the flow in the OFS are stored in the field. The OFS 160 can obtain the statistical information from the OFC 170 via an OpenFlow protocol.

The OFC 170 manages the flow entries 164 included in the flow table 162 held by the OFS 160. Specifically, the management by the OFC 170 includes setting, updating, deletion, and the like of the flow entries 164.

As described in the “Background Art” section, when the OFC has received the query about the first packet from the OFS, the OFC sets a new flow entry to the OFS. In this exemplary embodiment, when the OFC 170 has received a play setting notification from the resource control device 150, the OFC 170 also sets a new flow entry to the OFS indicated by the play setting notification. This play setting notification is performed by the play setting control unit 154 of the resource control device 150.

The play setting control unit 154 transmits the play setting notification to the OFC 170 in parallel with the instruction by the generation instruction issuing unit 152 to issue an instruction to generate a virtual machine. The play setting notification includes information necessary for generating the flow entry corresponding to the communication by the virtual machine generated by the hypervisor 120 according to the generation instruction issued by the generation instruction issuing unit 152. Specifically, the necessary information includes the 12 elements within the rule shown in FIG. 3, the corresponding action, and the corresponding statistical information. The necessary information is hereinafter referred to as “flow information”. For example, “source MAC address” and “source IP address” in the rule respectively correspond to the MAC address and the IP address of the virtual machine corresponding to the generation instruction issued by the generation instruction issuing unit 152, and “destination MAC address” and “destination IP address” are addresses set by the play setting control unit 154.

Upon receiving the play setting notification from the play setting control unit 154, the OFC 170 generates the flow entry corresponding to the flow information included in the play setting notification, and sets the generated flow entry to the OFS 160.

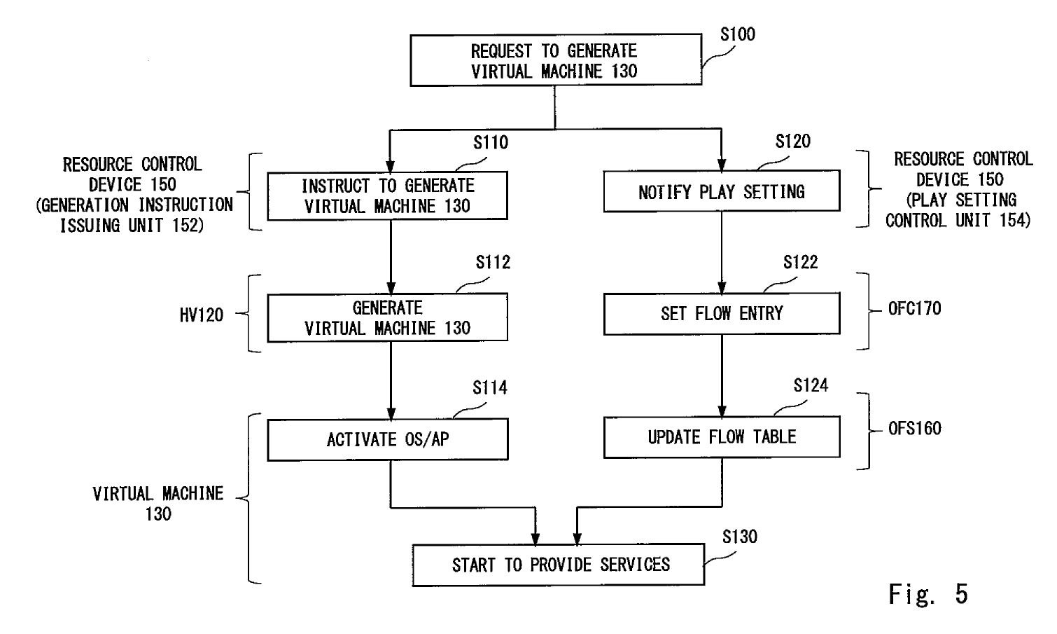

Referring to FIG. 5, a flow from the issuance of an instruction to generate the virtual machine 130 by the resource control device 150 to the start of provision of services by the virtual machine 130 in a state where the virtual machine 130 has not been generated yet will be described.

Upon receiving a request to generate the virtual machine 130 (S100), the resource control device 150 causes the generation instruction issuing unit 152 to issue an instruction to generate the virtual machine 130 to the hypervisor 120 (S110). In parallel with the issuance of the generation instruction by the generation instruction issuing unit 152, the play setting control unit 154 of the resource control device 150 transmits a play setting notification to the OFC 170 (S120).

Upon receiving the instruction to generate the virtual machine 130 from the generation instruction issuing unit 152, the hypervisor 120 generates the virtual machine 130 (S112), and the generated virtual machine 130 activates an OS and an application (S114).

In parallel with the processing from steps S112 to S114, the OFC 170 creates a flow entry based on the flow information included in the play setting notification from the play setting control unit 154, and sets the flow entry to the OFS 160 (S122). The OFS 160 updates the flow table 162 according to the setting by the OFC 170 (S124).

Accordingly, in step S114, when the activation of the OS and the application by the virtual machine 130 are completed, that is, when the virtual machine 130 is ready to provide services, the flow entry for relaying the communication by the virtual machine 130 is already present in the flow table 162 of the OFS 160. Therefore, the virtual machine 130 can readily perform communication via the OFS 160 and can start to provide services.

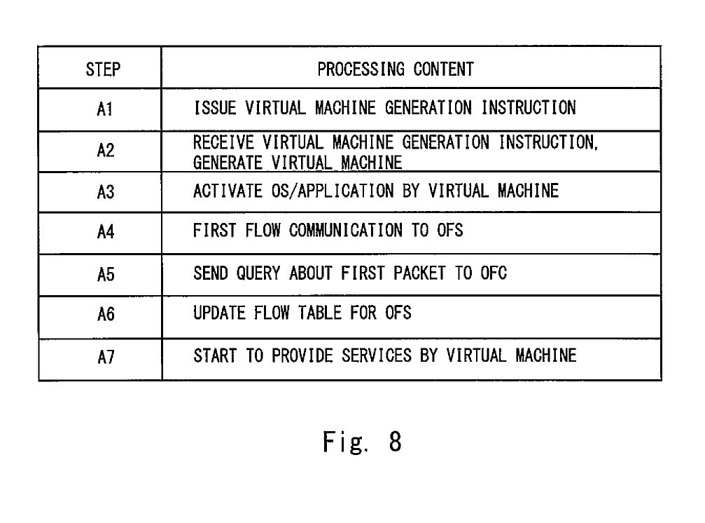

Referring to the flow of related art shown in FIG. 8, it is obvious that, in the network system 100 according to this exemplary embodiment, the processing corresponding to Steps A4 to A6 to be started after Step A2 in the related art is carried out during the processing of Steps A1 to A2. In other words, according to the network system 100 of this exemplary embodiment, the time required from the generation of a new virtual machine to the start of provision of services by the virtual machine can be shortened.

Further, if a number of OFSs send the query about the first packet to the OFC in the system in which a new virtual machine is frequently generated, there is a problem that the load on the OFC becomes extremely large. According to the network system 100 of this exemplary embodiment, the OFC that relays the communication by the virtual machine does not send the query about the first packet in the case of generating a new virtual machine, which leads to a reduction in the load on the OFC.

### Second Exemplary Embodiment

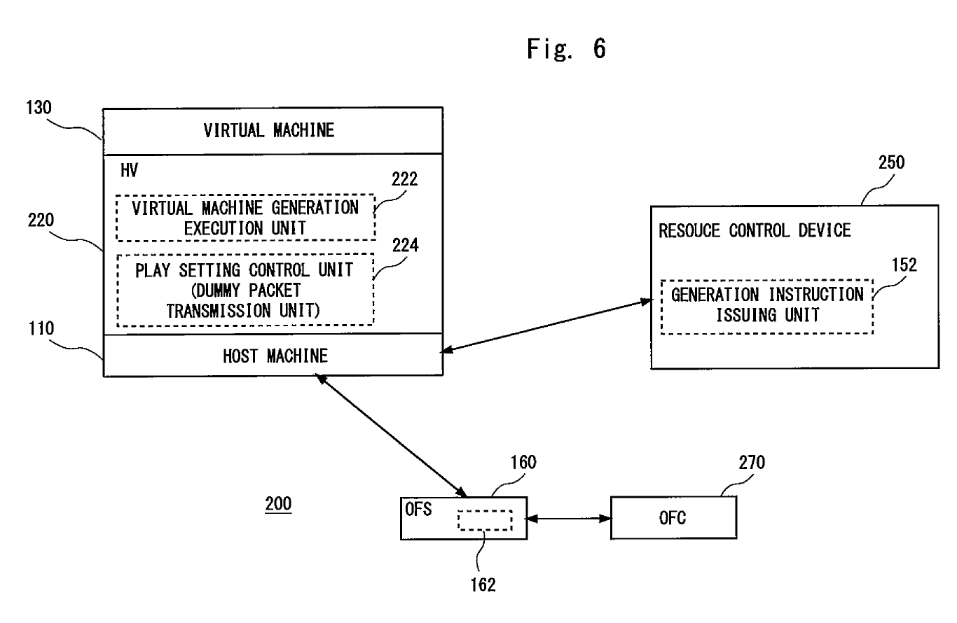

FIG. 6 shows a network system 200 according to a second exemplary embodiment. The network system 200 is also a system to which the OpenFlow technique is applied. The network system 200 includes the host machine 110, a resource control device 250, the OFS 160, and an OFC 270. The host machine 110, the resource control device 250, the OFS 160, the OFC 270 are connected to each other via a network (not shown).

A hypervisor 220 is implemented on the host machine 110. In this exemplary embodiment, the hypervisor 220 includes a play setting control unit 224 as well as a virtual machine generation execution unit 222 which has a function similar to that of the hypervisor 120 in the network system 100. The play setting control unit 224 will be described later.

The resource control device 250 differs from the resource control device 150 of the network system 100 in that the resource control device 250 includes only the generation instruction issuing unit 152 while it does not include the play setting control unit 154.

The OFC 270 has a function similar to that of the OFC of this type in the related art and differs from the OFC 170 of the network system 100 in that the OFC 270 is not controlled by the resource control device 250.

When the instruction to generate a new virtual machine is issued from the resource control device 250 to the hypervisor 220, the virtual machine generation execution unit 222 in the hypervisor 220 generates the virtual machine in the same manner as that in the hypervisor 120 in the network system 100. The play setting control unit 224 transmits a dummy packet including the flow information to the OFS 160 in parallel with the generation of the virtual machine by the virtual machine generation execution unit 222. In other words, in this exemplary embodiment, the play setting control unit 224 is a dummy packet transmission unit included in the hypervisor 220.

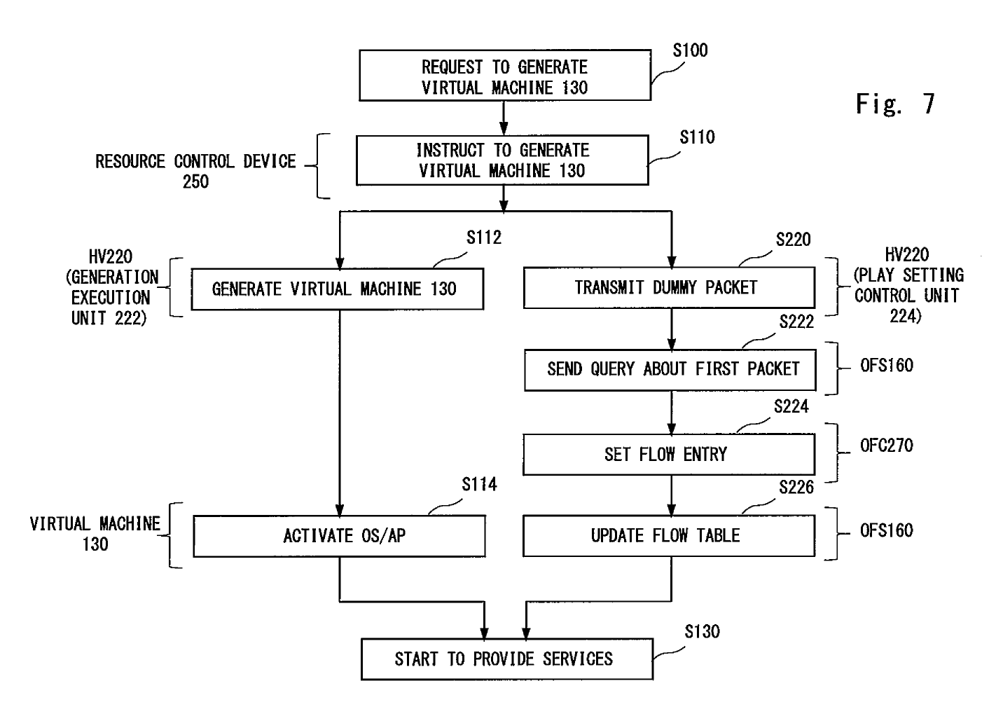

Referring to FIG. 7, a flow from the issuance of an instruction to generate the virtual machine 130 by the resource control device 250 to the start of provision of services by the virtual machine 130 in a state where the virtual machine 130 has not been generated yet will be described.

Upon receiving a request to generate the virtual machine 130 (S100), the resource control device 250 causes the generation instruction issuing unit 152 to issues an instruction to generate the virtual machine 130 to the hypervisor 220 (S110).

Upon receiving the instruction to generate the virtual machine 130 from the generation instruction issuing unit 152, the hypervisor 220 causes the virtual machine generation execution unit 222 to generate the virtual machine 130 (S112), and the generated virtual machine 130 activates an OS and an application (S114).

In parallel with the processing of step S112, the play setting control unit 224 in the hypervisor 220 transmits a dummy packet to the OFS 160 (S220). The header of the dummy packet includes the flow information necessary for generating the flow entry corresponding to the communication by the virtual machine 130.

Since the dummy packet is a first packet for the OFS 160, the OFS 160 sends a query about the first packet to the OFC 270 (S222). The OFC 270 creates a flow entry based on the flow information included in the query about the first packet from the OFS 160, and sets the flow entry to the OFS 160 (S224). The OFS 160 updates the flow table 162 according to the setting by the OFC 270 (S226).

Accordingly, in step S114, when the activation of the OS and the application by the virtual machine 130 are completed, that is, when the virtual machine 130 is ready to provide services, the flow entry for relaying the communication by the virtual machine 130 is already present in the flow table 162 of the OFS 160. Therefore, the virtual machine 130 can readily perform communication via the OFS 160 and can start to provide services.

In sum, according to the network system 200 of this exemplary embodiment, as in the network system 100, the processing of Steps A4 to A6 (see FIG. 8) to be started after Step A2 in the related art is carried out during the processing of Steps A1 to A2. Thus, in the network system 200 of this exemplary embodiment also, the time required from the generation of a new virtual machine to the start of provision of services by the virtual machine can be shortened.

The present invention has been described above with reference to exemplary embodiments. The above exemplary embodiments are merely examples, and various alterations, additions, omissions, and combinations may be made to the above exemplary embodiments, without departing from the scope of the present invention. It can be understood by those skilled in the art that modified examples obtained by these alterations, additions, omissions, and combinations also fall within the scope of the present invention.

For example, in the network system 100 according to the first exemplary embodiment, the play setting control unit 154 is included in the resource control device 150 and directly transmits the flow information to the OFC 170, thereby causing the OFC 170 to set the flow entry. In the network system 200, the play setting control unit 224 is included in the hypervisor 220 and transmits a dummy packet to cause the OFS 160 to send the query about the first packet, thereby causing the OFC 270 to set the flow entry. The dummy packet transmission unit similar to the play setting control unit 224 may be provided in the hypervisor, and the play setting control unit 154 may be provided in the resource control device that issues an instruction to generate a virtual machine.

In this case, during generation of a new virtual machine, the dummy packet transmission unit provided in the hypervisor and the play setting control unit provided in the resource control device may be selectively operated. For example, the resource control device may transmit the flow information to the OFCs which can be controlled from the resource control device, simultaneously with the instruction to generate a virtual machine, and the hypervisor may transmit a dummy packet to the OFCs which cannot be controlled from the resource control device, in parallel with the generation of the virtual machine.

The whole or part of the exemplary embodiments disclosed above can be described as, but not limited to, the following supplementary notes.

### <Supplementary Note 1>

A network system comprising:

a flow controller that sets a flow entry to a switch on a communication path, the switch relaying a received packet according to the flow entry included in a flow table held by the switch;

a virtual machine generation unit that generates a virtual machine according to an instruction to generate the virtual machine that performs communication through the switch; and

a play setting control unit that transmits, to the flow controller, information necessary for generating a flow entry corresponding to the communication by the virtual machine generated by the virtual machine generation unit, in parallel with issuance of the instruction to generate the virtual machine,

wherein the flow controller generates the flow entry according to the necessary information received from the play setting control unit, and sets the flow entry to the switch.

### <Supplementary Note 2>

The network system according to Supplementary note 1, wherein the play setting control unit is included in a resource control device that issues the instruction to generate the virtual machine.

### <Supplementary Note 3>

The network system according to Supplementary note 1, wherein

the play setting control unit is a dummy packet transmission unit included in the virtual machine generation unit, and

the dummy packet transmission unit transmits a dummy packet including the necessary information to the switch in parallel with the generation of the virtual machine upon reception of the generation instruction, thereby causing the switch to request the flow controller to set the flow entry according to the necessary information.

### <Supplementary Note 4>

A resource control device that issues a virtual machine generation instruction to a virtual machine generation unit in a network system, the network system including: a flow controller that sets a flow entry to a switch on a communication path, the switch relaying a received packet according to the flow entry included in a flow table held by the switch; and the virtual machine generation unit that generates the virtual machine according to an instruction to generate the virtual machine that performs communication through the switch, the resource control device comprising:

a play setting control unit that transmits, to the flow controller, information necessary for generating a flow entry corresponding to the communication by the virtual machine generated by the virtual machine generation unit, in parallel with issuance of the instruction to generate the virtual machine, thereby causing the flow controller to generate the flow entry according to the necessary information and set the flow entry to the switch.

### <Supplementary Note 5>

A virtual machine generation device in a network system including a flow controller that sets a flow entry to a switch on a communication path, the switch relaying a received packet according to the flow entry included in a flow table held by the switch, the virtual machine generation device comprising:

a virtual machine generation execution unit that generates a virtual machine according to an instruction to generate the virtual machine that performs communication through the switch; and

a dummy packet transmission unit that transmits, to the switch, a dummy packet including information necessary for generating a flow entry corresponding to the communication by the virtual machine, in parallel with the generation of the virtual machine by the virtual machine generation execution unit, thereby causing the switch to request the flow controller to set the flow entry according to the necessary information.

### <Supplementary Note 6>

A communication method in a network system including: a flow controller that sets a flow entry to a switch on a communication path, the switch relaying a received packet according to the flow entry included in a flow table held by the switch; and a virtual machine generation unit that generates a virtual machine according to an instruction to generate the virtual machine that performs communication through the switch, the communication method comprising:

a first step of issuing the instruction to generate the virtual machine to the virtual machine generation unit;

a second step of transmitting, to the flow controller, information necessary for generating a flow entry corresponding to the communication by the virtual machine generated by the virtual machine generation unit, in parallel with the issuance of the instruction to generate the virtual machine; and

a third step of generating, by the flow controller, the flow entry according to the received necessary information, and setting, by the flow controller, the flow entry to the switch.

### <Supplementary Note 7>

The communication method according to Supplementary note 6, wherein

the second step is a step of transmitting, by the virtual machine generation unit, a dummy packet including the necessary information to the switch in parallel with the generation of the virtual machine upon reception of the generation instruction, and

the third step is a step of setting, by the flow controller, the flow entry in response to a request to set the flow entry according to the necessary information, the request being made to the flow controller by the switch upon reception of the dummy packet.

### <Supplementary Note 8>

A play setting control method in a network system including: a flow controller that sets a flow entry to a switch on a communication path, the switch relaying a received packet according to the flow entry included in a flow table held by the switch; and a virtual machine generation unit that generates a virtual machine according to an instruction to generate the virtual machine that performs communication through the switch, the play setting method comprising:

transmitting, to the flow controller, information necessary for generating a flow entry corresponding to the communication by the virtual machine generated by a virtual machine generation unit, in parallel with issuance of the instruction to generate the virtual machine to the virtual machine generation unit in the network system, thereby causing the flow controller to generate the flow entry according to the necessary information and set the flow entry to the switch.

### <Supplementary Note 9>

A play setting control method in a network system including a flow controller that sets a flow entry to a switch on a communication path, the switch relaying a received packet according to the flow entry included in a flow table held by the switch, the play setting control method comprising:

transmitting, to the switch, a dummy packet including information necessary for generating a flow entry corresponding to communication by a virtual machine, in parallel with generation of the virtual machine according to an instruction to generate the virtual machine that performs communication through the switch, thereby causing the switch to request the flow controller to set the flow entry according to the necessary information.

### <Supplementary Note 10>

A program for causing a computer to execute processing in a network system including: a flow controller that sets a flow entry to a switch on a communication path, the switch relaying a received packet according to the flow entry included in a flow table held by the switch; and a virtual machine generation unit that generates a virtual machine according to an instruction to generate the virtual machine that performs communication through the switch, the processing comprising:

a first step of issuing an instruction to generate the virtual machine to the virtual machine generation unit; and

a second step of transmitting, to the flow controller, information necessary for generating a flow entry corresponding to the communication by the virtual machine generated by the virtual machine generation unit, in parallel with the issuance of the instruction to generate the virtual machine, thereby causing the flow controller to generate the flow entry according to the necessary information and set the flow entry to the switch.

### <Supplementary Note 11>

The program according to Supplementary note 10, wherein

the second step is a step of causing the virtual machine generation unit to perform processing of transmitting a dummy packet including the necessary information to the switch, in parallel with the generation of the virtual machine upon reception of the generation instruction, and

the third step is a step of causing the flow controller to perform processing of setting the flow entry in response to a request to set the flow entry according to the necessary information, the request being made to the flow controller by the switch upon reception of the dummy packet.

### <Supplementary Note 12>

A program for causing a computer to execute processing in a network system including: a flow controller that sets a flow entry to a switch on a communication path, the switch relaying a received packet according to the flow entry included in a flow table held by the switch; and a virtual machine generation unit that generates a virtual machine according to an instruction to generate the virtual machine that performs communication through the switch, the processing comprising:

transmitting, to the flow controller, information necessary for generating a flow entry corresponding to the communication by the virtual machine generated by the virtual machine generation unit, in parallel with issuance of the instruction to generate the virtual machine to the virtual machine generation unit in the network system, thereby causing the flow controller to generate the flow entry according to the necessary information and set the flow entry to the switch.

### <Supplementary Note 13>

A program for causing a computer to execute processing in a network system including a flow controller that sets a flow entry to a switch on a communication path, the switch relaying a received packet according to the flow entry included in a flow table held by the switch, the processing comprising:

transmitting, to the switch, a dummy packet including information necessary for generating a flow entry corresponding to communication by a virtual machine, in parallel with generation of the virtual machine according to an instruction to generate the virtual machine that performs communication through the switch, thereby causing the switch to request the flow controller to set the flow entry according to the necessary information.

While the present invention has been described above with reference to exemplary embodiments, the present invention is not limited by the above exemplary embodiments. The configuration and details of the present invention can be modified in various ways which can be understood by those skilled in the art within the scope of the invention.

This application is based upon and claims the benefit of priority from Japanese patent application No. 2013-040956, filed on Mar. 1, 2013, the disclosure of which is incorporated herein in its entirety by reference.

### REFERENCE SIGNS LIST

100 Network System
110 Host Machine
120 Hypervisor
130 Virtual Machine
150 Resource Control Device
152 Generation Instruction Issuing Unit
154 Play Setting Control Unit
160 OFS (Openflow Switch)
162 Flow Table
164 Flow Entry
170 OFC (Openflow Controller)
200 Network System
220 Hypervisor
222 Virtual Machine Generation Execution Unit
224 Play Setting Control Unit (Dummy Packet Transmission Unit)
250 Resource Control Device
270 OFC (Openflow Controller)

1. A network system comprising:
a flow controller that sets a flow entry to a switch on a communication path, the switch relaying a received packet according to the flow entry included in a flow table held by the switch; and
a virtual machine generation unit that generates a virtual machine according to an instruction to generate the virtual machine that performs communication through the switch, wherein
the virtual machine generation unit includes a play setting control unit that transmits, to the switch, a dummy packet including information necessary for generating a flow entry corresponding to the communication by the virtual machine, in parallel with the generation of the virtual machine upon reception of the generation instruction, and
upon receiving a setting request output from the switch upon reception of the dummy packet, the flow controller generates the flow entry according to the necessary information included in the setting request, and sets the flow entry to the switch.

2. A virtual machine generation device in a network system including a flow controller that sets a flow entry to a switch on a communication path, the switch relaying a received packet according to the flow entry included in a flow table held by the switch, the virtual machine generation device comprising:
a virtual machine generation execution unit that generates virtual machine according to an instruction to generate the virtual machine that performs communication through the switch; and
a dummy packet transmission unit that transmits, to the switch, a dummy packet including information necessary for generating a flow entry corresponding to the communication by the virtual machine, in parallel with the generation of the virtual machine by the virtual machine generation execution unit, thereby causing the switch to request the flow controller to set the flow entry according to the necessary information.

3-5. (canceled)

6. A play setting control method in a network system including a flow controller that sets a flow entry to a switch on a communication path, the switch relaying a received packet according to the flow entry included in a flow table held by the switch, the play setting control method comprising:
transmitting, to the switch, a dummy packet including information necessary for generating a flow entry corresponding to communication by a virtual machine, in parallel with generation of the virtual machine according to an instruction to generate the virtual machine that performs communication through the switch, thereby causing the switch to request the flow controller to set the flow entry according to the necessary information.
